(19) United States
(12) Patent Application Publication
(10) Pub. No.: US 2020/0114824 A1
(43) Pub. Date: Apr. 16, 2020

(54) PIVOT POSITION SENSOR FOR FOLDING REARVIEW ASSEMBLIES

(71) Applicant: MOTHERSON INNOVATIONS COMPANY LIMITED, London (GB)

(72) Inventor: Paul Henion, Troy, MI (US)

(21) Appl. No.: 16/542,797

(22) Filed: Aug. 16, 2019

(30) Foreign Application Priority Data
Sep. 13, 2018 (CN) 201821500285.5

(51) Int. Cl. B60R 1/12; B60R 1/074

(52) U.S. Cl. CPC B60R 1/12; B60R 2001/1223; B60R 1/074

(57) ABSTRACT

A manual or automatic folding vehicle rearview assembly is disclosed. An embodiment of the rearview assembly comprises a bracket mountable to a vehicle, a rearview element mounted to the bracket via a rotatable pivot, and a position signaling device between the rearview element and the bracket, wherein the position signaling device is configured to detect a rotational position of the rearview element relative to the bracket and communicate the rotational position to a vehicle camera system.

### CROSS-REFERENCE TO RELATED APPLICATIONS

This application claims the benefit of priority to Chinese Patent Application No. CN 201821500285.5, filed on Nov. 16, 2018, which is hereby incorporated by reference in its entirety for all purposes.

### TECHNICAL FIELD

The present disclosure relates generally to external vehicle rearview assemblies and more specifically to external manual or automatic folding rearview assemblies having pivot position sensors.

### BACKGROUND

External vehicle rearview mirrors can be designed to rotationally fold inward towards the side of the vehicle. Currently, folding mirrors can be manually or automatically adjustable, allowing the vehicle operator to rotationally position the mirror head by hand. Often, other systems within the vehicle are dependent on the rotational position of the mirror, such as vehicle cameras—a situation particularly applicable within the field of the autonomous vehicles. Therefore, for optimal vehicle performance, the rotational position of the external mirrors (and other rearview assemblies) should be communicated to the affected vehicle camera systems.

### SUMMARY

In one aspect, a manual or automatic folding external vehicle rearview assembly includes a position sensor for interfacing with a vehicle camera system. An embodiment of a rearview assembly includes a bracket mountable to a vehicle, a rearview element mounted to the bracket via a rotatable pivot, and a position signaling device between the rearview element and the bracket, wherein the position signaling device is configured to detect a rotational position of the rearview element relative to the bracket and communicate that position to a vehicle camera system.

An embodiment of the position signaling device includes a micro-switch sensor for detecting the rotational position of the rearview element, wherein the micro-switch sensor is positioned between the rearview element and the bracket and is configured to contact the bracket when the rearview assembly is in a driving position, and retract away from the bracket when the rearview assembly is in a folded position. The micro-switch sensor provides a signal to a vehicle camera system based on the contact to communicate the rotational position of the rearview element. An alternative embodiment of the position signaling device includes a rotation angle sensor, wherein the rotation angle sensor measures the rotational position of the rearview element between a folded position and a driving position and provides a signal to the vehicle camera system in response to that measured position.

### BRIEF DESCRIPTION OF THE DRAWINGS

The foregoing summary, as well as the following detailed description, will be better understood when read in conjunction with the appended drawings. For the purpose of illustration, certain examples of the present disclosure are shown in the drawings. It should be understood, however, that the present disclosure is not limited to the precise arrangements and instrumentalities shown. The accompanying drawings, which are incorporated in and constitute a part of this specification, illustrate an implementation of system, apparatuses, and methods consistent with the present disclosure and, together with the detailed description, serve to explain advantages and principles consistent with the present disclosure, wherein:

FIG. 1 depicts an example vehicle rearview assembly, including a micro-switch position sensor, in a driving position;

FIG. 2 depicts an example vehicle rearview assembly, including a micro-switch position sensor, in a folded position; and

FIG. 3 depicts an example vehicle rearview assembly, including a rotation angle sensor, in a driving position.

### DETAILED DESCRIPTION

It is to be understood that the disclosure is not limited in its application to the details of construction and to the arrangements of the components set forth in the following description or illustrated in the drawings. The figures and written description are provided to teach those skilled in the art to make and use the inventions for which patent protection is sought. The disclosure is capable of other embodiments and of being practiced and carried out in various ways. Those skilled in the art will appreciate that not all features of a commercial embodiment are shown for the sake of clarity and understanding. Those skilled in the art will also appreciate that the development of an actual commercial embodiment incorporating aspects of the present disclosure may require numerous implementation-specific decisions to achieve the developer's ultimate goal for the commercial embodiment.

In addition, it is to be understood that the phraseology and terminology employed herein are for the purpose of describing the present disclosure and should not be regarded as limiting. For example, the use of a singular term, such as, “a” is not intended as limiting of the number of items. Also, the use of relational terms, such as but not limited to, “top,” “bottom,” “left,” “right,” “upper,” “lower,” “down,” “up,” “side,” are used in the description for clarity in specific reference to the figures and are not intended to limit the scope of the present disclosure. Further, it should be understood that any one of the features may be used separately or in combination with other features. Other systems, methods, features, and advantages will be or become apparent to those skilled in the art upon examination of the figures and the description. It is intended that all such additional systems, methods, features, and advantages be included within this description, and be within the scope of the present disclosure.

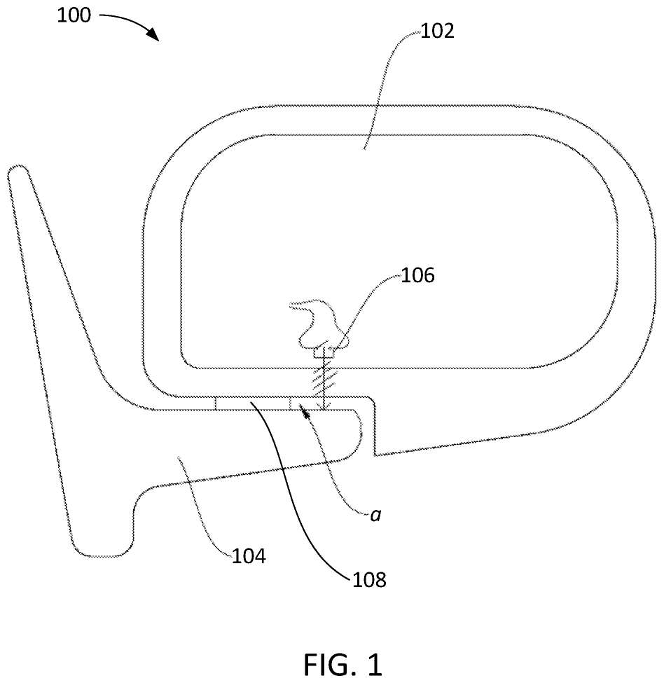

FIG. 1 depicts an embodiment of an external vehicle rearview assembly, including a micro-switch position sensor, in a driving position. The rearview assembly 100 includes rearview element 102, mounting bracket 104, micro-switch position sensor 106, and pivot 108. In embodiments, mounting bracket 104 serves to attach the rearview assembly 100 to the side of a vehicle.

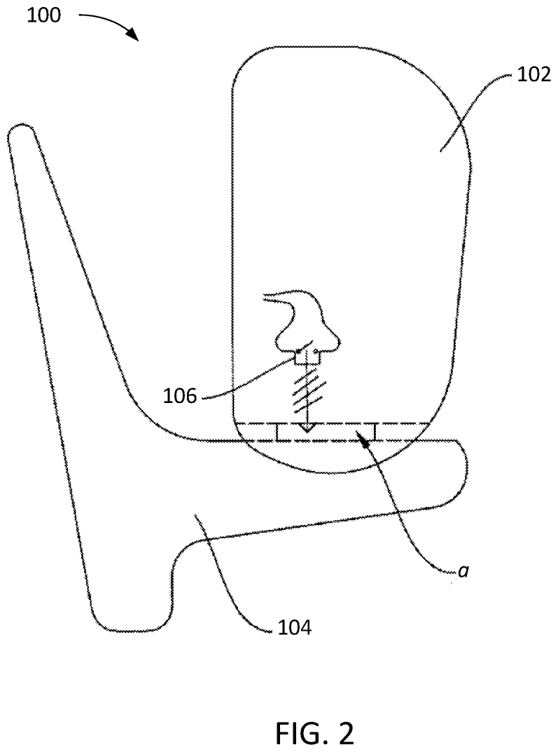

In the depicted embodiment, rearview element 102 is coupled to mounting bracket 104 via pivot 108. Pivot 108 provides a rotatable axis that allows rearview element 102 to manually or automatically transition between a driving position (depicted in FIG. 1) and a folded position (depicted in FIG. 2). In the driving position, the rearview assembly 100 is fully extended, providing a rearview image of the vehicle's surroundings. In the folded position, the rearview assembly 100 is folded towards the side of the vehicle and no longer provides a rearview image.

Returning to FIG. 1, embodiments of rearview assembly 100 include a micro-switch position sensor 106 mounted to the rearview element 102. The micro-switch sensor 106 is a position signaling device designed to communicate the position of the rearview assembly 100 to a vehicle camera system. Based on the position of the rearview assembly 100 (e.g., driving or folded position), the contact situation of the micro-switch sensor 106 is changed, and the switch transitions between an open and closed configuration. The change in contact yields a varying electric signal that is interfaced with the vehicle's camera system. This feedback signal indicates the difference in the camera's ability to capture a proper viewing angle due to the rearview assembly's changed position.

The micro-switch sensor 106 is activated by a linear up and down motion that occurs when the pivoting rearview assembly 100 is manually or automatically folded. When the rearview assembly is in the driving position (as seen in FIG. 1), micro-switch sensor 106 extends through gap a to contact mounting bracket 104. When the rearview assembly 100 is in the folded position (as seen in FIG. 2), micro-switch sensor 106 is sufficiently raised within gap a so as to not be in contact with the mounting bracket 104. The change in contact provides a feedback signal that interfaces with the vehicle camera system to communicate the rotational position of the rearview assembly.

Although the FIGS. 1 and 2 embodiment shows the micro-switch sensor 106 mounted to the rearview element 102, in alternative embodiments, the position sensor 106 is mounted in the bracket 104. In other embodiments, the position sensor 106 is mounted in a horizontal fashion, as opposed to the substantially vertical mounting in FIGS. 1 and 2. Sensors mounted horizontally may be designed to detect rotational or angular motion of the rearview assembly 100 in order to signal the transition between the driving and folded position to the camera system.

In embodiments, a potentiometer system is employed in concert with the micro-switch position sensor. The potentiometer system provides varying return voltages to determine exactly what position the rearview assembly is in. Such a system can record the displacement of the micro-switch sensor to determine if the rearview assembly is in the driving or folded position, or somewhere in between.

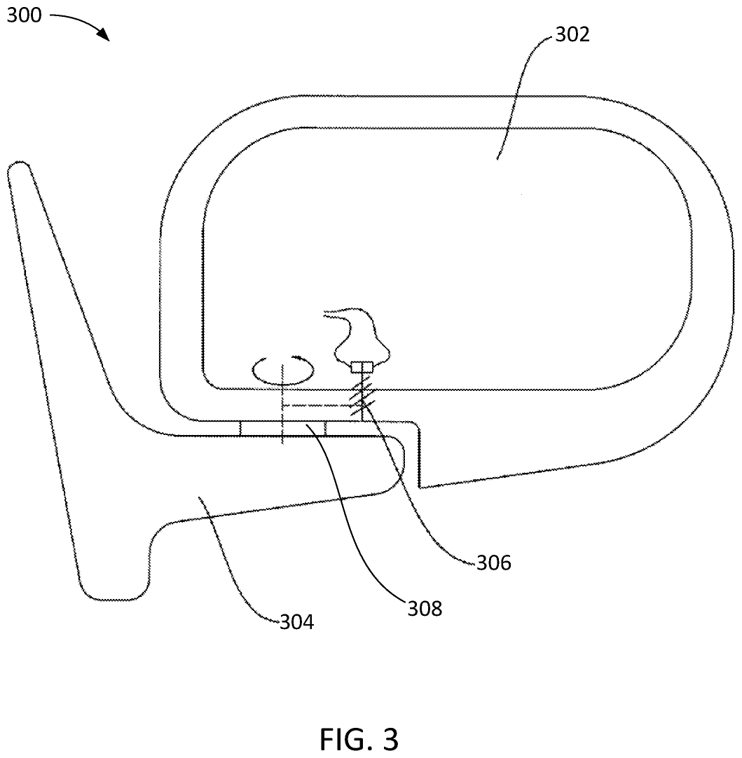

Turning to FIG. 3, an alternative embodiment of a vehicle rearview assembly in a driving position is depicted. Like the embodiment of FIGS. 1 and 2, vehicle rearview assembly 300 includes a rearview element 302, mounting bracket 304, pivot 308, and a position signaling device designed to interface with a vehicle camera system. But in the FIG. 3 embodiment, the position signaling device is a rotation angle sensor 306, not a micro-switch position sensor as previously described.

Rotation angle sensor 306 is configured to measure the rotational or angular motion of rearview element 302 around pivot 308. As pictured in FIG. 3, pivot 308 provides a substantially vertical axis around which rearview element 302 can rotate between the driving and folded positions. Rotation angle sensor 306 measures such rotations and communicates with the camera system to convey whether the rearview assembly is in the driving position, folded position, or somewhere in between.

In embodiments, rotation angle sensor 306 is mounted on mounting bracket 304 instead of rearview element 302. Additionally, like micro-switch sensor 106 described above, rotation angle sensor 306 can also be mounted horizontally.

Throughout the application, reference is made to rearview assemblies 100, 300 and rearview elements 102, 302. A rearview element 102, 302 may include a mirror for providing a rearview image of surroundings or may include a display unit or any other screen or electronic unit capable of displaying an image of the surroundings. For example, the rearview assembly 100, 300 may include, in addition to mirror assemblies, any camera or sensor assembly which uses a camera or sensor to detect and ultimately display an image of the surroundings.

It should be understood that as used in the description herein and throughout the claims that follow, the meaning of “a,” “an,” and “the” includes the plural reference unless the context clearly dictates otherwise. Also, as used in the description herein and throughout the claims that follow, the meaning of “in” includes “on” unless that context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate a situation where only the disjunctive meaning may apply.

The invention has been described with reference to particular exemplary embodiments. However, it will be readily apparent to those skilled in the art that it is possible to embody the invention in specific forms other than those of the exemplary embodiments described above. The embodiments are merely illustrative and should not be considered restrictive. The scope of the invention is reflected in the claims, rather than the preceding description, and all variations and equivalents which fall within the range of the claims are intended to be embraced therein.

What is claimed is:

1. A folding vehicle rearview assembly, comprising:
a bracket mountable to a vehicle;
a rearview element mounted to the bracket via a rotatable pivot; and
a position signaling device located between the rearview element and the bracket,
wherein the position signaling device is configured to detect a rotational position of the rearview element relative to the bracket and communicate the rotational position to a vehicle camera system.

2. The rearview assembly of claim 1, wherein the position signaling device is a micro-switch sensor, and the micro-switch sensor provides a signal to the vehicle camera system in response to detecting the rotational position of the rearview element.

3. The rearview assembly of claim 2, wherein:
the micro-switch sensor is extended to contact the bracket in response to the rearview assembly being in a drive position,
the micro-switch sensor is retracted away from the bracket in response to the rearview assembly being in a folded position, and
the signal is provided based on the contact of the micro-switch sensor.

4. The rearview assembly of claim 3, further comprising a potentiometer system to record a displacement of the micro-switch sensor resulting from a change in the rotational position of the rearview element.

5. The rearview assembly of claim 1, wherein the position signaling device is a rotation angle sensor, and the rotation angle sensor measures the rotational position of the rearview element between a folded position and a driving position.

6. The rearview assembly of claim 5, wherein the rotation angle sensor provides a signal to the vehicle camera system in response to measuring the rotational position of the rearview element.

7. The rearview assembly of claim 1, wherein the rotational position of the rearview element is at least one of adjusted manually and automatically.

8. A folding vehicle rearview assembly, comprising:
a bracket mountable to a vehicle;
a rearview element mounted to the bracket by a pivot, wherein the rearview element varies its rotational position with respect to the bracket between a driving position and a folded position via the pivot; and
a micro-switch sensor for detecting the rotational position of the rearview element,
wherein the micro-switch sensor is positioned between the rearview element and the bracket and is configured to:
contact the bracket in response to the rearview assembly being in the driving position;
retract away from the bracket in response to the rearview assembly being in the folded position; and
provide a signal to a vehicle camera system based on the contacting or retracting away of the micro-switch sensor from the bracket to communicate the rotational position of the rearview element.

9. The rearview assembly of claim 8, further comprising a potentiometer system to record a displacement of the micro-switch sensor resulting from a change in the rotational position of the rearview element.

10. The rearview assembly of claim 8, wherein the rotational position of the rearview element is at least one of adjusted manually and automatically.

11. A folding vehicle rearview assembly, comprising:
a bracket mountable to a vehicle;
a rearview element mounted to the bracket by a pivot, wherein the rearview element varies its rotational position with respect to the bracket between a driving position and a folded position via the pivot; and
a rotation angle sensor positioned between the rearview element and the bracket,
wherein the rotation angle sensor measures the rotational position of the rearview element and communicates the measured rotational position to a vehicle camera system.

12. The rearview assembly of claim 11, wherein the rotational position of the rearview element is at least one of adjusted manually and automatically.
